(19) United States
(12) Patent Application Publication
(10) Pub. No.: US 2025/0142278 A1
(43) Pub. Date: May 1, 2025

(54) Method Of Compressing An Impulse Response Set

(71) Applicant: Sony Interactive Entertainment Europe Limited, London (GB)

(72) Inventors: Calum Armstrong, London (GB); Danjeli Schembri, London (GB); Philip Cockram, London (GB)

(73) Assignee: Sony Interactive Entertainment Europe Limited, London (GB)

(21) Appl. No.: 18/923,877

(22) Filed: Oct. 23, 2024

(30) Foreign Application Priority Data
Oct. 27, 2023 (GB) GB2316458.5

(51) Int. Cl. H04S 7/00

(52) U.S. Cl. CPC H04S 7/30; H04S 2420/01

(57) ABSTRACT

A method of compressing an impulse response set, the impulse response set comprising a plurality of impulse responses. The method comprises identifying at least one common impulse response element in the plurality of impulse responses, each common impulse response element being present in at least some of the plurality of impulse responses. The or each common impulse response element is removed from each of the impulse responses identified as comprising that common impulse response element, thereby generating a corresponding set of compressed impulse responses. Then, the compressed impulse responses, the identified common impulse response elements and, for each identified common impulse response element, mapping data representing a mapping of that common impulse response element to the compressed impulse responses from which it was removed, are stored.

### CROSS-REFERENCE TO RELATED APPLICATION

The present application claims priority from United Kingdom Patent Application No. GB2316458.5 filed Oct. 27, 2023, the disclosure of which is hereby incorporated herein by reference.

### FIELD OF THE INVENTION

This invention relates to a method of compressing impulse response data. Specifically, the invention provides a method of compressing an impulse response set which comprises a plurality of impulse responses. Head-Related Transfer Functions (HRTFs) are an example of data that can be represented by such an impulse response set, and the method finds particular application in the context of 3D audio, where there is often a need to store large numbers of HRTFs.

### BACKGROUND

In video game development, 3D audio techniques are widely used to generate sounds that seem to emanate from specific locations in the environment that forms the setting of the game. This adds a sense of depth and realism to the player's experience by enabling the player to perceive sounds coming from different directions and distances.

HRTFs are commonly used in the implementation of 3D audio. HRTFs describe the way in which a person hears sound in 3D, and can change depending on the position of the sound source. Typically, in order to calculate a received sound y(f, t), a signal x(f, t) transmitted by the sound source is combined with (e.g. multiplied by, or convolved with) the transfer function H(f).

HRTFs are individual to each person and depend on things like the size of their head and shape of their ear, with each ear having its own corresponding HRTF. HRTFs are typically broken down into three main features: interaural time difference (ITD) corresponding to the time delay between the left and right ears, interaural level difference (ILD) corresponding to the volume difference between the left and right ears, and spectral features such as pinnae notches causing frequency variations as sound waves reflect off a particularly shaped ear. A user's HRTF profile can be adjusted to provide differing effects on the sound perceived by the user.

In video game 3D audio, a user's HRTF profile typically comprises a set of impulse responses (IRs). Each impulse response represents a respective location in space and determines how a sound originating at that location will be transformed under the user's HRTF profile. HRTFs typically include separate IRs for the left and right ears, so each location will typically be associated with two impulse responses, reflecting the fact that the left and right ears will generally respond differently to a sound originating from any particular location. Each IR itself comprises multiple samples, typically hundreds or thousands. The HTRF profile therefore represents a large data set comprising hundreds of thousands of individual samples, which both requires significant data storage space and limits the level of detail that can practically be captured in HRTFs in video game applications. There is a need for a way of addressing these challenges.

### SUMMARY OF INVENTION

A first aspect of the invention provides a method of compressing an impulse response set, the impulse response set comprising a plurality of impulse responses, the method comprising: identifying at least one common impulse response element in the plurality of impulse responses, each common impulse response element being present in at least some of the plurality of impulse responses; removing the or each common impulse response element from each of the impulse responses identified as comprising that common impulse response element, thereby generating a corresponding set of compressed impulse responses; storing the compressed impulse responses, the identified common impulse response elements and, for each identified common impulse response element, mapping data representing a mapping of that common impulse response element to the compressed impulse responses from which it was removed.

The method above provides a technique for reducing the size of an IR set. The inventors have realised that, while IRs are generally large, complex data objects, many of the IRs in a set such as an HRTF profile typically have significant features in common with one another. The “common impulse response element” identified in the method above is a feature that is present in a plurality of the IRs in the IR set, which is removed from the IRs in which it is present and mapped to those IRs. This means that only one instance of the common impulse response element needs to be stored, and the sizes of the IRs in which it appeared are reduced by its removal from them. For example, IRs in the time domain often contain many samples with zero values, and one common impulse response element could be a string of zeros occurring at a certain set of locations in the IR (e.g. the last 50 samples in the time domain).

Typically the “common impulse response element” will be a specific sequence of sample values that is present in the impulse responses from which it is subsequently removed. For example, if the sequence of samples [10, 8, 6] appears in several impulse responses, this could be treated as a common impulse response element. The common impulse response element could be at different positions in the impulse responses from which it is removed: for example, in one impulse response the sequence above could be the first-third values, and in another the fifth-seventh. The mapping of the common impulse response element to the compressed impulse responses may specify the location in the or each compressed impulse response to which the common impulse response element maps.

In some preferred embodiments, removing the common impulse response element from each of the plurality of impulse responses identified as comprising that common impulse response element comprises performing a reverse convolution on each of the plurality of impulse responses identified as comprising that common impulse response element. This is particularly advantageous in cases where the “common impulse response element” is not be a sequence of specific, common values. For example, each impulse response could exhibit a high-frequency roll-off, which will not appear in the impulse responses as a specific sequence of values but rather will affect the overall form of the impulse response. If the form of the roll-off is known, it can be remove from the impulse responses by reverse convolution, which simplifies the impulse responses. As another example, the common impulse response element could be a filter which, when deconvolved from the original IRs, results in compressed IRs that are simpler than the original IRs and possibly suitable for further compression, e.g. by removing trailing zeros.

Preferably the impulse response set represents a head-related transfer function, HRTF, each of the plurality of impulse responses representing the value of the HRTF at a respective sound source position. However, methods in accordance with this invention may be applied to other kinds of impulse response data and give rise to the same advantages discussed above. It is noted that the HRTF, when represented in the time domain (rather than the frequency domain) is sometimes referred to as the Head-Related Impulse Response (HRIR). However, in this specification, the term HRTF will be used to refer to both frequency-domain and time-domain data.

Preferably, in the case where the impulse response set represents an HRTF as described above, identifying the at least one common impulse response element comprises: selecting a spatial sub-region of the space formed by the sound source positions of the impulse responses; identifying a common impulse response element in the impulse responses whose sound source positions fall within the spatial sub-region. Often the impulse responses representing a sub-region of the space spanned by an HRTF are similar (because sounds originating from similar locations are generally expected to undergo similar transformations under the HRTF), so the impulse responses in the sub-region of the space are likely to share one or more common impulse response elements. For example, the spatial subregion could be defined as all left-ear impulse responses within 20 degrees of due left and all right-ear impulse responses within 20 degree of due right.

In preferred implementations, a plurality of common impulse response elements are identified, wherein at least some of the impulse responses comprise two or more of the identified common impulse response elements, the method comprising removing said two or more identified common impulse response elements from each of the impulse responses identified as comprising said two or more identified common impulse response elements. In other words, some or all of the impulse responses may contain more than one common impulse response element—for example, two impulse responses might both contain a common sequence of samples at the beginning and a common set of trailing zeros at the end.

Preferably, the impulse responses are minimum phase time impulse responses. By “minimum phase” it is meant that there is minimal phase offset at the beginning. This is particularly advantageous where the minimum phase impulse responses are in the time domain, since this maximises the number of trailing zeros in the impulse responses and hence increases the size of the common elements that can be removed.

As noted above, impulse responses often contain a set of “trailing zeros” or other trailing values. Therefore, preferably, at least one of the identified common response elements comprises a set of trailing values, wherein preferably trailing values are zeros. By “trailing values” we mean the last n (e.g. last 10 or last 50) samples in the impulse response. In the case of a time domain impulse response, the trailing values represent the last n samples in time. Often, particularly in the case of time domain impulse responses, the trailing values will be zeros. For example, the following impulse response, which contains 10 samples, has five trailing zeros: [8, −1, 6, 1, 5, 0, 0, 0, 0, 0]. As a second example, the following impulse response has four trailing zeros: [3, 4, 5, 1, 3, 2, 0, 0, 0, 0]. The two impulse responses share four trailing zeros as a common impulse response element. They also share a second common impulse response element, which is that the value of the fourth sample is 1.

Advantageously, the method may further comprise transforming the compressed impulse responses into minimum phase impulse responses. The method preferably then further comprises, before storing the compressed impulse responses: defining a threshold trailing value; and removing from the compressed impulse responses any trailing values having a magnitude below the magnitude of the threshold trailing value. The compressed impulse responses may contain trailing values that are non-zero but which are nonetheless small and make a minor contribution to the overall effect of the impulse response on sounds to which it is applied. For example, a compressed impulse response [10, 9, 9, 7, 0, 0, 0, 1, 0, 0] includes a 1 after the trailing values following the 7, but the effect of this 1 is minor. The impulse response would produce substantially the same effects if the 1 in the compressed impulse response were replaced with a zero. In these embodiments, the threshold trailing value could be set to a value such as 2, which would result in the trailing zeros and the 1 being removed from the compressed impulse response. This enables additional storage space to be saved (since the six trailing values would be removed and, when reconstructing the impulse response from the compressed impulse response, the six trailing values of the compressed impulse response would each be set to zero). Performing this step may result in some of the compressed impulse responses having different lengths to others (since some impulse responses may have more trailing values below the threshold than others) but, nevertheless, all of the impulse responses can be reconstructed simply by adding enough trailing zeros to each compressed impulse response to restore it to its original value.

The method preferably further comprises: identifying at least one common sub-element in the plurality of common impulse response elements, each common sub-element being present in at least some of the common impulse response elements; removing the or each common sub-element from each of the common impulse response elements identified as comprising that common sub-element, thereby generating a corresponding set of compressed common impulse response elements; and storing the compressed common impulse response elements, and, for each identified common sub-element, mapping data representing a mapping of that common sub-element to the compressed common impulse response element from which it was removed. The common impulse response elements can thus be further compressed by identifying and extracting common sub-elements. For example, if it were found that one group of impulse responses include the common impulse response element [12, 10, 6] as the first three samples in the impulse response and another group of impulse responses shared the common impulse response element [10, 10, 6] as their first three samples, it would be identified that these two common impulse response elements share a common sub-element [10, 6] as the second and third samples. The original versions of the common impulse response elements that have been compressed (which were stored after removing them from the IRs in which they were found to be present) may be discarded after storing the compressed impulse response elements.

The invention also provides a method of obtaining an impulse response, the method comprising: performing the method defined above; selecting one of the compressed impulse responses corresponding to the impulse response to be obtained; reconstructing the compressed impulse response using the mapping data associated with the compressed impulse response and the stored common impulse response element represented in said mapping data.

Reconstructing the compressed impulse response may involve adding the common element back into the compressed impulse response—for example, adding a sequence of trailing zeros onto the end of the compressed impulse response from which they were removed. In cases where the common impulse response element was removed by reverse convolution, reconstructing the IRs may comprise convolving each of the compressed IRs with the common impulse response element.

A second aspect of the invention provides a method of compressing an impulse response database, the impulse response database comprising a plurality of impulse response sets, each impulse response set comprising a plurality of impulse responses, the method comprising: computing a common impulse response set; removing the common impulse response set from each of the impulse response sets corresponding simplified impulse response sets; storing the simplified impulse response sets and the common impulse response set.

This method provides a way of compressing an impulse response database, which, as will be shown below, is particularly advantageous for reducing the size of a database containing multiple HRTFs each comprising a respective impulse response set. By removing the common impulse response set from each of the impulse response sets, the stored impulse response sets are simplified such that only the differences of each impulse response set relative to the common impulse response set (and the common impulse response set itself) need to be stored. This is particularly useful for HRTF databases because, although each HRTF profile is different, HRTF profiles generally share many features in common and are typically unique by virtue of relatively small differences. The method above thus enables all the information required to reconstruct each HRTF to be stored without storing each HRTF in full.

It should be noted that the “common impulse response set” here is not necessarily present in the impulse response sets from which it is removed: for example, the common impulse response set could be an average of all the stored impulse responses, but no one impulse response set will exactly match this average set. By contrast, in the first aspect above, the “common impulse response element” typically refers to a feature (e.g. a sequence of samples) present in the impulse responses from which it was removed.

Preferably each of the impulse response sets is a respective HRTF.

Preferably, computing the common impulse response set comprises computing an average of some or all of the impulse response sets or sub-sets thereof at each location represented by those impulse response sets. Because HRTFs will generally be similar to one another, differing in terms of relatively small details, a significant portion of the information that is present in each HRTF can be captured by computing the average. Most advantageously, each of the impulse response sets is a respective HRTF, the impulse responses of each HRTF comprising a left-ear subset and a right-ear subset, and computing the average comprises: for the HRTFs to be averaged, spatially inverting either the left-ear subsets or the right-ear subsets of those HRTFs along the left-right direction; computing an average of the inverted left-ear or right-ear subsets and the non-inverted subsets of the HRTFs to be averaged at each location represented by those subsets. The left-ear and right-ear parts of each HRTF will generally be similar to one another when inverted in this manner: for example, the right ear will perceive a sound originating 10 metres to the left and 1 metre in front very similarly to how the left ear will perceive the same sound when it originates 10 metres to the right and 1 metre in front. Therefore, when one is inverted along the left-right direction, the left-ear and right-ear parts of each HRTF are similar to one another and can both be used to compute the average. In this scenario, the common impulse response set may be stored for only one ear, in which case the impulse response set for the other ear can be obtained by spatially inverting the impulse response set reconstructed from the common impulse response set of the ear whose values were stored.

Once the impulse response sets (e.g. HRTFs) have been compressed in the manner just described, the simplified impulse response sets may themselves be compressed by a method in accordance with the first aspect of the invention.

In each aspect of the invention, the method is typically computer-implemented. For example, the impulse responses, impulse response sets and impulse response databases may be stored on a storage system such as a server and the method steps may be performed by a processor in communication with the storage system.

### BRIEF DESCRIPTION OF DRAWINGS

Examples of methods in accordance with embodiments of the invention will now be described with reference to the accompanying drawings, in which:

FIG. 1 schematically illustrates a 3D audio scenario;

FIG. 2 shows a system of coordinates for defining the positions of impulse responses in an HRTF.

### DETAILED DESCRIPTION

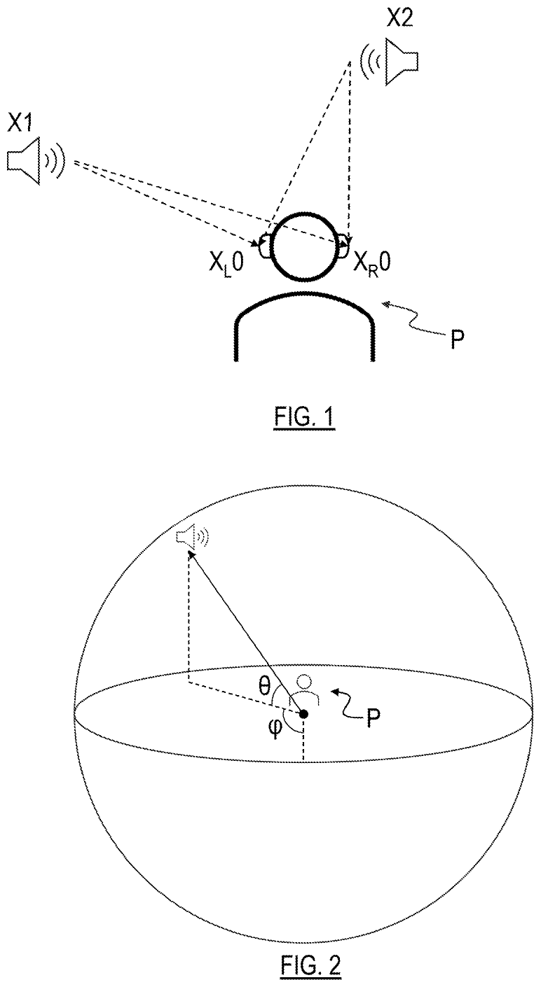

As explained above, 3D audio is implemented using HRTFs, which contain information about how sounds originating at different locations in space will be perceived by the user to which the HRTF relates. The HRTF is represented by a set of “impulse responses” (IRs), which are objects describing how an audio impulse originating at a specific location (relative to the user) will be heard by the user. Typically the IRs are stored as sequences of samples, each sample representing the amplitude of the sound perceived by the user at a respective point in time after the time of the impulse (e.g. at intervals of 0.01 seconds). For example, an IR beginning [20, 15, 12, 10, . . . ] represents the sound being perceived as initially loud and then quickly diminishing at each time step. How the user actually perceives the impulse depends at where it originates in space, relative to them, so the values of the impulse response vary spatially. Additionally, each ear generally perceives the impulse differently, reflecting the fact that the sound travels a different path to each ear. The HRTF therefore contains impulse responses for each of the left and right ears at each position. This is illustrated in FIG. 1: a sound originating at a first location X1 relative to the user P travels along different paths to the locations of the left ear (XL0) and the right ear (XR0) and is perceived different by each ear. The same sound when originating from a different, second location X2 will sound different. The user can sense which direction the sound originates from based on these differences.

A simplified example of the HRTF profile for a user is given in Table 1. In this example, the IRs represent different angular locations, defined in terms of an azimuthal angle 0°≤φ<360° and a longitudinal angle −90°<θ<90° about the position of the user's head as illustrated in FIG. 2. Here φ=0° is the direction straight ahead of the user, so φ=90° is due right of the user and φ=270° is due left. In this example, there is an IR every 10 degrees in each angular direction (for brevity most are not listed). Consequently, for each ear, there are 36×19=684 IRs, meaning there are 1386 IRs in total. If each IR has a length of 512 samples (representing a time interval between samples of e.g. 0.01 seconds), this means that a total of 700,416 samples must be stored for this one HRTF. This kind of time-domain representation of the HRTF is sometimes referred to as the HRIR, though in this specification we use the term HRTF to refer to both time-domain and frequency-domain representations.

TABLE 1
HRTF profile for user 1

| Position (φ, θ) (°) | Left-ear IR | Right-ear IR |
|---|---|---|
| 0, 0 | [8, 6, 3, . . . 0, 0, 0] | [8, 5, 3, . . . 0, 0, 0] |
| 10, 0 | [9, 6, 3, . . . 0, 0, 0] | [8, 5, 3, . . . 0, 0, 0] |
| 20, 0 | [9, 6, 4, . . . 1, 0, 0] | [7, 5, 2, . . . 0, 0, 0] |
| . | . | . |
| . | . | . |
| . | . | . |
| 350, 90 | [9, 7, 3, . . . 0, 0, 0] | [7, 6, 3, . . . 0, 1, 0] |

The first aspect of the invention provides a method of compressing an impulse response set such as the HRTF shown in Table 1. An embodiment of this method will now be described with reference to the Table 1 example. It should be noted that, for ease of understanding, this example is simplified, relative to typical real HRTFs, in terms of the number and lengths of IRs and common elements involved.

First, at least one common impulse response element is identified in the plurality of impulse responses, each common impulse response element being present in at least some of the plurality of impulse responses. In Table 1, it can be seen that the left-ear IRs at (0, 0) and (10, 0) and the right-ear IR at (350, 90) all include the sequence [6, 3] as the second and third samples. This sequence is therefore a common impulse response element shared by these IRs.

Next, the or each common impulse response element is removed from each of the impulse responses identified as comprising that common impulse response element, thereby generating a corresponding set of compressed impulse responses. For example, for the left-ear IR at (0, 0), the element [6, 3] is removed so that the compressed IR becomes: [8, . . . 0, 0, 0]. Consequently, the compressed IR is two values shorter than the IR in its original form. Similarly, the right-ear IR at (350, 90) becomes [7, . . . 0, 1, 0] when compressed. The compressed impulse responses, the identified common impulse response elements and, for each identified common impulse response element, mapping data representing a mapping of that common impulse response element to the compressed impulse responses from which it was removed are stored. For the example of the compressed IR above, the common impulse response element [6, 3], the compressed IR [8, . . . 0, 0, 0], and mapping data indicating that the element [6, 3] maps to the second and third positions of the compressed IR are stored.

The original IR can be reconstructed using the stored compressed IR, common impulse response element and mapping data: from the mapping data, it can be determined that the original IR can be obtained by inserting the element [6, 3] at the second and third positions of the compressed IR, thereby restoring the original IR [8, 6, 3, . . . 0, 0, 0].

It will be noted that the three trailing values in each of the compressed IRs [8, . . . 0, 0, 0] and [7, . . . 0, 1, 0] are small values, either 0 or 1. The small but non-zero trailing values such as the 1 in the second compressed IR will generally have a minimal effect on the user's perception of sounds transformed in accordance with that IR, but nonetheless consume as much storage space as other values. To further compress the IR set, the method may comprise defining a threshold value and removing from the compressed IRs any trailing values below the threshold values. In this case, setting the threshold at 2 would result in the three trailing values in each of the two compressed IRs above being removed. When reconstructing the compressed IRs, zeros will be added to the ends of the compressed IRs to restore them to their original lengths (in this case, three zeros being added to the end of each of the two IRs). This means that the some of the restored IRs will differ from their original versions (e.g. the IR [7, 6, 3, . . . 0, 1, 0], after compression and then restoration will become [7, 6, 3, . . . 0, 0, 0]) but this has a minimal influence on the sounds perceived by the user and achieves further compression of the IRs.

In the example just described with reference to Table 1, the common impulse response element was a sequence of values and removing this element from the impulse response involved simply removing those values from the impulse response, resulting in a shorter impulse response. However, in alternative embodiments, the removal of the common impulse response element(s) may alternatively comprise performing a reverse convolution on the impulse responses identified as comprising that common impulse response element. This is advantageous where the common impulse response element is not a specific sequence of sample values but some other common feature such as a filter (e.g. delay) applied to each impulse response. An example of this will now be described. Consider the two example signals below, “example signal 1” and “example signal 2”.
Example signal 1: [0, 1, 2, 3, 2, 1, 0, 0, 0, 0, 0, 0]
Example signal 2: [0, 3, 3, 3, 3, 3, 00, 0, 0, 0, 0] Suppose that two impulse responses in the impulse response set, example IR 1 and example IR 2, correspond respectively to example signal 1 and example signal 2 each convolved with the following filter: [2, 1]. Example IR 1 and example IR 2 are then as follows:
Example IR 1: [0, 2, 5, 8, 7, 4, 1, 0, 0, 0, 0, 0]
Example IR 2: [0, 6, 9, 9, 9, 9, 3, 0, 0, 0, 0, 0]

In cases such as this, identifying the common impulse response element could comprise identifying the filter. Removing the common impulse response element would then comprise performing a reverse convolution on the impulse responses. The compressed impulse responses would then correspond to example signal 1 and example signal 2, which are simpler than example IR 1 and example IR 2 in the sense that they have more trailing zeros. These compressed impulse responses are particularly suitable for further compression by removing the trailing zeros in the manner described previously. In cases where the common impulse response element was removed by reverse convolution, reconstructing the IRs may comprise convolving each of the compressed IRs with the common impulse response element.

In the example described above with reference to Table 1, common impulse response elements were identified in IRs across the range of coordinates shown. However, it can be beneficial to look for common impulse response elements in specification sub-regions of the space covered because IRs that are close to one another in space: for example, all IRs within +20° of due left (so those with in the region 250°≤φ<290°) are expected to share a degree of similarity and therefore a high proportions of IRs in this range will share common impulse response elements with one another. Identifying the common impulse response elements may therefore involve looking for common impulse response elements among the IRs in one or more such spatial sub-regions.

The stored common impulse response elements may themselves be compressed. As an example, the following three common impulse response elements could be stored after performing applying the steps above to an IR set (e.g. HRTF profile): [6, 6, 4, 8], [4, 8, 3, 1, 1] and [0, 4, 8, 3, 0, 0]. Each of these common impulse response elements contains the sub-element [4, 8], so this sub-element could be removed from each of the common impulse response elements above, thereby generating a corresponding set of compressed common impulse response elements. Alternatively, the second and third common impulse response elements both contain the sub-element [4, 8, 3], so this sub-element could be removed from those while leaving the first impulse response element unchanged. The compressed common impulse response elements, and, for each identified common sub-element, mapping data representing a mapping of that common sub-element to the compressed common impulse response element from which it was removed, would then be stored and the common impulse response elements may be restored in a manner analogous to the way in which the impulse response elements are restored described above.

The second aspect of the invention provides a method of compressing an impulse response database. As noted above, method is suitable for compressing an impulse response database comprising a plurality of impulse response sets, each impulse response set comprising a plurality of impulse responses. An example of such a database is a database storing the HRTFs of multiple users, in which each HRTF is represented as a set of impulse responses (e.g. as described above with reference to Table 1). The method of the first aspect described above compresses an impulse response set based on a recognition of the fact that there will be features in common between individual IRs in the IR set. By contrast, the method of the second aspect aims to compress the database by taking advantage of similarities between the whole impulse response sets (e.g. HRTFs). An impulse response data could be a database containing many (e.g. 10s or 100s) of HRTFs of the kind shown in Table 1, for example. The HRTFs would all have the same format, i.e. impulse responses for each of an array of positions around the user's head, but the precise sequence of samples in the IR at each location will generally differ from one HRTF to another. However, all of the HRTFs will display many similar features: for example, the general manner in which the values in the IRs vary with spatial coordinates will be similar for all HRTFs. This method therefore involves computing a “common impulse response set” which contains much of the information that is common to all the IR sets and removing this information from each of the stored IR set so that only the differences between each IR set and the common impulse response set need to be stored.

First, the common impulse response set is computed. In the case of a database containing a plurality of HRTFs of the form shown in Table 1, this can be achieved as follows. First, all the right-ear IRs (of each IR set) are spatially inverted along the left-right direction. This means that the coordinates of the right-ear IRs are “mirrored” in the plane that lies perpendicular to (and half-way along) the line between the user's ears. For example, the right-ear IR at coordinates φ=20°, θ=40° is mapped to the coordinates φ=340°, θ=40° (in other words, it goes from being 20° to the right of the ‘straight ahead’ direction, in which φ=0°, to 20° to the left). The rationale for this is that the HRTF will usually be approximately symmetric in the plane separating the user's left and right sides, so by inverting the coordinates of the IRs for one ear, the left-ear and right-ear IRs can be combined for the computation of the common IR set.

After spatially inverting the right-ear IRs, the left-ear IRs and spatially-inverted right-ear IRs of each HRTF are averaged at each set of coordinates. For example, all the left-ear IRs at coordinates φ=20°, θ=40°, and all the spatially-inverted right-ear IRs that were mapped to these coordinates, are averaged. Computing this average could involve for example averaging the values of the samples of the IRs at each time set. This results in a common impulse response set, which in this case is an average of all the HRTFs that represents the general form of the HRTFs in the database.

The common impulse response set is then removed from each of the impulse response sets, e.g. by inverse convolution, thereby producing corresponding simplified impulse response sets. Removing the common impulse response set from the IR sets can be achieved by subtracting the sample values of the common impulse response set from the corresponding sample values in each individual HRTF. The resulting simplified impulse responses represent how each impulse response (HRTF) differs from the common impulse response set (in this example the average). The simplified impulse response sets and the common impulse response set are then stored, and any of the original impulse response sets can be restored by re-adding the common impulse response set to the simplified impulse response set that is of interest.

Once the impulse response sets (e.g. HRTFs) have been compressed in the manner just described, the simplified impulse response sets may themselves be compressed in by a method in accordance with the first aspect of the invention.

1. A method of compressing an impulse response set, the impulse response set comprising a plurality of impulse responses, the method comprising:
identifying at least one common impulse response element in the plurality of impulse responses, each common impulse response element being present in at least some of the plurality of impulse responses;
removing the at least one common impulse response element from each of the impulse responses identified as comprising that common impulse response element, thereby generating a corresponding set of compressed impulse responses; and
storing the compressed impulse responses, the identified common impulse response elements and, for each identified common impulse response element, mapping data representing a mapping of that common impulse response element to the compressed impulse responses from which it was removed.

2. The method of claim 1, wherein the impulse response set represents a head-related transfer function (HRTF), each of the plurality of impulse responses representing the value of the HRTF at a respective sound source position.

3. The method of claim 2, wherein identifying the at least one common impulse response element comprises:
selecting a spatial sub-region of the space formed by the sound source positions of the impulse responses; and
identifying a common impulse response element in the impulse responses whose sound source positions fall within the spatial sub-region.

4. The method of claim 1, wherein a plurality of common impulse response elements are identified, wherein at least some of the impulse responses comprise two or more of the identified common impulse response elements, the method comprising removing the two or more identified common impulse response elements from each of the impulse responses identified as comprising the two or more identified common impulse response elements.

5. The method of claim 1, wherein removing the common impulse response element from each of the plurality of impulse responses identified as comprising that common impulse response element comprises performing a reverse convolution on each of the plurality of impulse responses identified as comprising that common impulse response element.

6. The method of claim 1, wherein the impulse responses are minimum phase impulse responses.

7. The method of claim 6, wherein at least one of the identified common response elements comprises a set of trailing values, wherein preferably trailing values are zeros.

8. The method of claim 1, further comprising transforming the compressed impulse responses into minimum phase impulse responses.

9. The method of claim 1, further comprising, before storing the compressed impulse responses:
defining a threshold trailing value; and
removing from the compressed impulse responses any trailing values having a magnitude below the magnitude of the threshold trailing value.

10. The method of claim 1, further comprising:
identifying at least one common sub-element in the plurality of common impulse response elements, each common sub-element being present in at least some of the common impulse response elements;
removing the at least one common sub-element from each of the common impulse response elements identified as comprising that common sub-element, thereby generating a corresponding set of compressed common impulse response elements; and
storing the compressed common impulse response elements, and, for each identified common sub-element, mapping data representing a mapping of that common sub-element to the compressed common impulse response element from which it was removed.

11. The method of claim 1, further comprising:
selecting one of the compressed impulse responses corresponding to an impulse response to be obtained; and
reconstructing the compressed impulse response using the mapping data associated with the compressed impulse response and the common impulse response element represented in the mapping data.

12. The method of claim 11, wherein reconstructing the compressed impulse response comprises computing a convolution of the common impulse response element represented in the mapping data with the compressed impulse response.

13. A method of compressing an impulse response database, the impulse response database comprising a plurality of impulse response sets, each impulse response set comprising a plurality of impulse responses, the method comprising:
computing a common impulse response set;
removing the common impulse response set from each of the impulse response sets, thereby producing corresponding simplified impulse response sets; and
storing the simplified impulse response sets and the common impulse response set.

14. The method of claim 13, wherein each of the impulse response sets is a respective head-related transfer function (HRTF).

15. The method of claim 13, wherein computing the common impulse response set comprises computing an average of some or all of the impulse response sets or sub-sets thereof at each location represented by those impulse response sets.

16. The method of claim 15, wherein each of the impulse response sets is a respective head-related transfer function (HRTF), the impulse responses of each HRTF comprising a left-ear subset and a right-ear subset, and computing the average comprises:
for the HRTFs to be averaged, spatially inverting either the left-ear subsets or the right-ear subsets of those HRTFs along the left-right direction; and
computing an average of the inverted left-ear or right-ear subsets and the non-inverted subsets of the HRTFs to be averaged at each location represented by those subsets.
